(19) United States
(12) Patent Application Publication
(10) Pub. No.: US 2014/0250397 A1
(43) Pub. Date: Sep. 4, 2014

(54) USER INTERFACE AND METHOD

(71) Applicant: HONEYWELL INTERNATIONAL INC., Morristown, NJ (US)

(72) Inventors: Kamal Kannan, Madurai (IN); Manikandan Ramaswami, Sirkali (IN)

(73) Assignee: Honeywell International Inc., Morristown, NJ (US)

(21) Appl. No.: 13/783,507

(22) Filed: Mar. 4, 2013

(51) Int. Cl. G06F 3/0484

(52) U.S. Cl. CPC G06F 3/0484
USPC 715/771

(57) ABSTRACT

A user interface method can include providing an object to be controlled, providing a remote control device, capturing an image of the object, using the image of the object to recognize the object, and based on recognition of the object, displaying a second user interface on the viewing screen of the remote control device, wherein the second user interface is substantially identical to a first user interface of the object. A user interface method can also include providing an object to be controlled, providing a remote control device, focusing an image capturing device of the remote control device on the object, identifying coordinates, identifying the object as being associated with the identified coordinates, and based on identifying the object, displaying a second user interface on the viewing screen of the remote control device, wherein the second user interface is substantially identical to a first user interface of the object.

### FIELD

The present invention relates generally to a user interface and method of using a user interface. More particularly, the present invention relates to a user interface for controlling home automation devices and a method of using a user interface to control home automation devices.

### BACKGROUND

Home automation devices are known in the art. For example, a home automation device can include a thermostat, lock, switch, security panel, and the like. Each home automation device can include a user interface.

Remote control devices and applications for controlling home automation devices are also known in the art. For example, a remote control device or application can include a user interface, which can be used to remotely control a home automation system.

The user interface of a remote control device is different than the user interface of a home automation device. Therefore, a user will engage in different experiences depending on whether the user accesses the home automation device directly through the user interface of the home automation device or through the user interface of the remote control device. For example, the visual appearance and cues and/or the audio and sound indications of the user interfaces can vary. Accordingly, a learning curve may be associated with a user interface of a remote control device.

In view of the above, there is a continuing, ongoing need for an improved user interface.

### BRIEF DESCRIPTION OF THE DRAWINGS

FIG. 1 is a flow diagram of a method of remotely controlling an object recognized for the first time in accordance with disclosed embodiments;

FIG. 2 is a flow diagram of a method of remotely controlling an object that has previously been recognized in accordance with disclosed embodiments;

FIG. 3 is a block diagram of a remote control device for carrying out the methods of FIG. 1, FIG. 2, and others in accordance with disclosed embodiments; and

FIG. 4 is a perspective view of a system for carrying out the methods of FIG. 1, FIG. 2, and others in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a user interface of a remote control device or application that can be used to control a plurality of different home automation devices. In some embodiments, the user interface of the remote control device can be substantially identical to the user interface of the home automation device that the remote control device is controlling. That is, a user can engage in a substantially identical experience regardless of whether the user is accessing a home automation device directly through the home automation device's user interface or through a user interface of the remote control device. Because the user interface on the remote control application “matches” the user interface on the home automation device, a user's experience when using the user interface on the remote control device can be more intuitive, and any learning curve can be reduced.

The remote control device disclosed herein can include a cellular phone, smart phone, personal digital assistance, or any other remote control device as would be known by those of skill in the art. For example, in some embodiments, a software application can be downloaded and/or loaded onto the remote control device.

In accordance with disclosed embodiments, the user interface of the remote control device can change depending on the home automation device that the remote control device is controlling. For example, when the remote control device is controlling a first home automation device, the remote control device can display a first user interface that is substantially identical to a user interface of the first home automation device. However, when the remote control device is controlling a second home automation device, the remote control device can display a second user interface that is substantially identical to a user interface of the second home automation device.

Some embodiments of the remote control device disclosed herein can include a mechanism to identify a device or object to be controlled, for example, a home automation system to be controlled. For example, the remote control device can include a camera or other image capturing device to capture an image of the device or object. When an image is captured, embodiments disclosed herein can compare the captured image with a plurality of stored images, for example, in a training library. The device or object in the captured image can be recognized when embodiments disclosed herein match the captured image with one of the plurality of stored images.

After the device or object to be controlled is recognized, embodiments disclosed herein can provide and display a user interface on the remote control device for controlling the device or object. Embodiments disclosed herein can also associate the displayed user interface with the device or object. In some embodiments, the user interface that is displayed on the remote control device can be substantially identical to the user interface of the device or object itself. In some embodiments, three-dimensional rendering can be employed to display the device or object's user interface on the remote control device.

In some embodiments, when a device or object to be controlled is recognized, embodiments disclosed herein can provide a live status update for the device or object and/or facilitate a user's ability to remotely control the device or object. In some embodiments, events or videos related to the device and/or a list of items, such as a switch or lock, that are associated with the device or object can also be displayed to the user.

In some embodiments, when a device or object to be controlled is recognized, for example, when the device or object is recognized for the first time, coordinates can be identified and associated with the device or object. For example, in some embodiments, the coordinates of the user, the remote control device, and/or the camera or other image capturing device can be identified. In some embodiments, the coordinates of the recognized device or object to be controlled can be identified.

In some embodiments, the coordinates can be identified in relation to compass directions. In some embodiments, the coordinates can be identified as a location within a region, for example, a relative position with respect to other objects in the region. In some embodiments, the coordinates can be identified as geographic coordinates or as GPS coordinates.

The remote control device disclosed herein can continue to be used to remotely control a device or object after the coordinates of the device or object have been identified. For example, in some embodiments, when the camera or image capturing device is panned to an object or device that has previously been recognized, the user interface can provide and display the user interface associated with the object or device to be controlled. That is, embodiments disclosed herein can identify the current coordinates as being the same as previously identified coordinates, can identify the object or device associated with the current coordinates, and can provide and display the user interface associated with the identified object or device.

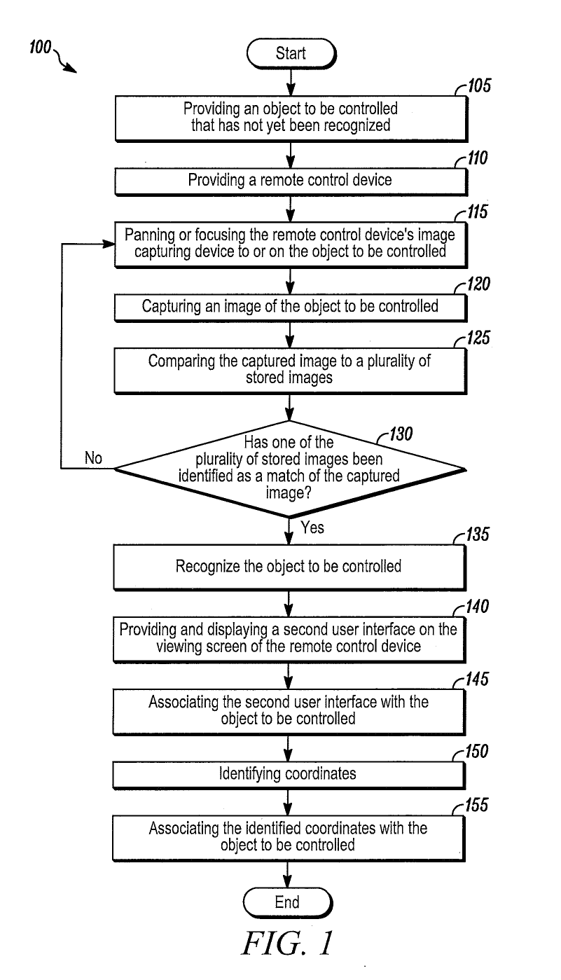

FIG. 1 is a flow diagram of a method 100 of remotely controlling an object recognized for the first time in accordance with disclosed embodiments. As seen in FIG. 1, the method 100 can include providing an object to be controlled that has not yet been recognized as in 105. For example, the object to be controlled can have a first user interface. The method 100 can also include providing a remote control device as in 110. For example, the remote control device can include a viewing screen and an image capturing device, such as a camera.

The method 100 can include panning or focusing the remote control device's image capturing device to or on the object to be controlled as in 115. Then, the method 100 can include capturing an image of the object to be controlled as in 120 and comparing the captured image to a plurality of stored images as in 125. When the method 100 determines that one of the plurality of stored images has been identified as a match of the captured image as in 130, the method 100 can recognize the object to be controlled as in 135.

After the object to be controlled has been recognized as in 135, the method 100 can include providing and displaying a second user interface on the viewing screen of the remote control device as in 140. For example, the second user interface can be substantially identical to the first user interface of the object to be controlled. The method can also include associating the second user interface with the object to be controlled as in 145.

Finally, the method 100 can include identifying coordinates as in 150 and associating the identified coordinates with the object to be controlled as in 155.

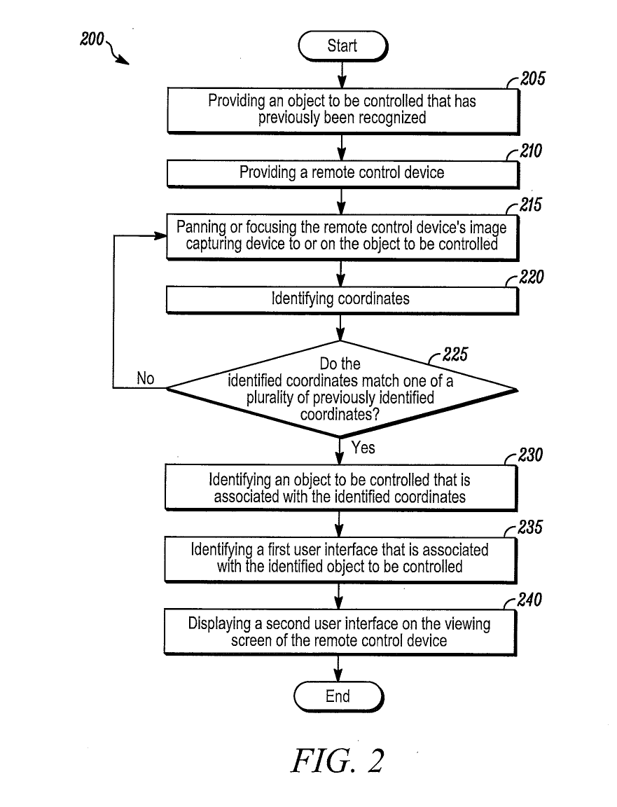

FIG. 2 is a flow diagram of a method 200 of remotely controlling an object that has previously been recognized in accordance with disclosed embodiments. As seen in FIG. 2, the method 200 can include providing an object to be controlled that has previously been recognized as in 205. For example, the object to be controlled can have a first user interface. The method 200 can also include providing a remote control device as in 210. For example, the remote control device can include a viewing screen and an image capturing device, such as a camera.

The method 200 can include panning or focusing the remote control device's image capturing device to or on the object to be controlled as in 215. Then, the method 200 can include identifying coordinates as in 220 and determining that the coordinates identified in step 220 match one of a plurality of previously identified coordinates as in 225. For example, the method 200 can determine that the coordinates identified in step 220 match the coordinates identified in step 150 of the method 100.

Then, the method 200 can include identifying an object to be controlled that is associated with the coordinates identified in step 220 as in 230. For example, the method 200 can identify the object to be controlled that was associated with the coordinates in step 155 of the method 100.

The method 200 can also include identifying a first user interface that is associated with the object to be controlled identified in step 230 as in 235. For example, the method 200 can identify the first user interface that was associated with the object to be controlled in step 145 of the method 100.

Finally, the method 200 can include displaying a second user interface on the viewing screen of the remote control device as in 240. For example, the second user interface can be substantially identical to the first user interface that was identified in step 235.

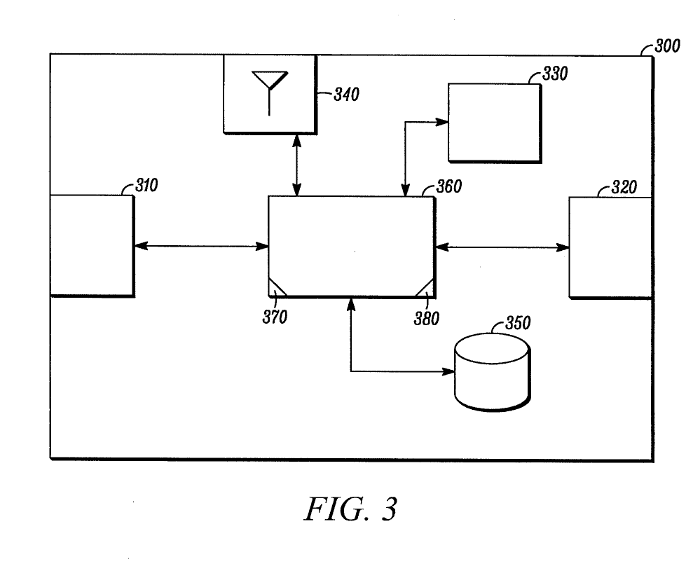

FIG. 3 is a block diagram of a remote control device 300 for carrying out the methods of FIG. 1, FIG. 2, and others in accordance with disclosed embodiments. As seen in FIG. 3, the device 300 can include a viewing screen 310, an image capturing device 320, a coordinate determining device 330, a wired and/or wireless transceiver 340, a memory device 350, control circuitry 360, one or more programmable processors 370, and executable control software 380. The executable control software 380 can be stored on a transitory or non-transitory computer readable medium, including but not limited to, computer memory, RAM, optical storage media, magnetic storage media, flash memory, and the like. In some embodiments, the executable control software 380 can execute the steps of the methods 100 and 200 shown in FIG. 1 and FIG. 2, respectively, as well as others disclosed herein.

The image capturing device 320 can pan or focus to or on an object to be controlled and to capture an image of the object to be controlled. For example, in some embodiments, the image capturing device 320 can include a camera. In some embodiments, the captured image can be stored in the memory device 350. In some embodiments, the captured image can be sent, via the transceiver 340, to a displaced system, server, or memory device.

When the captured image is compared to a plurality of stored images, the plurality of stored images can be retrieved from the memory device 350 or, via the transceiver 340, from a displaced system, server, or memory device.

A plurality of user interfaces can be displayed on the viewing screen 310. For example, a user interface that is substantially identical to a user interface of an object to be controlled can be displayed on the viewing screen 310. In some embodiments, the viewing screen 310 can display interactive and viewing windows. In some embodiments, the viewing screen 310 can be a multi-dimensional graphical user interface and can include input and output mechanisms as would be understood by those of ordinary skill in the art.

The coordinate determining device 330 can identify coordinates in accordance with embodiments disclosed herein. For example, in some embodiments, the coordinate determining device 330 can include a compass and/or a GPS receiver. In some embodiments, the identified coordinates can be stored in the memory device 350. In some embodiments, the identified coordinates can be sent, via the transceiver 340, to a displaced system, server, or memory device.

When an object to be controlled that is associated with identified coordinates is identified, the association data and/or the identification of the object to be controlled can be retrieved from the memory device 350 or, via the transceiver 340, from a displaced system, server, or memory device. Similarly, when the user interface that is associated with the identified object to be controlled is identified, the association data and/or the identification of the user interface can be retrieved from the memory device 350 or, via the transceiver 340, from a displaced system, server, or memory device.

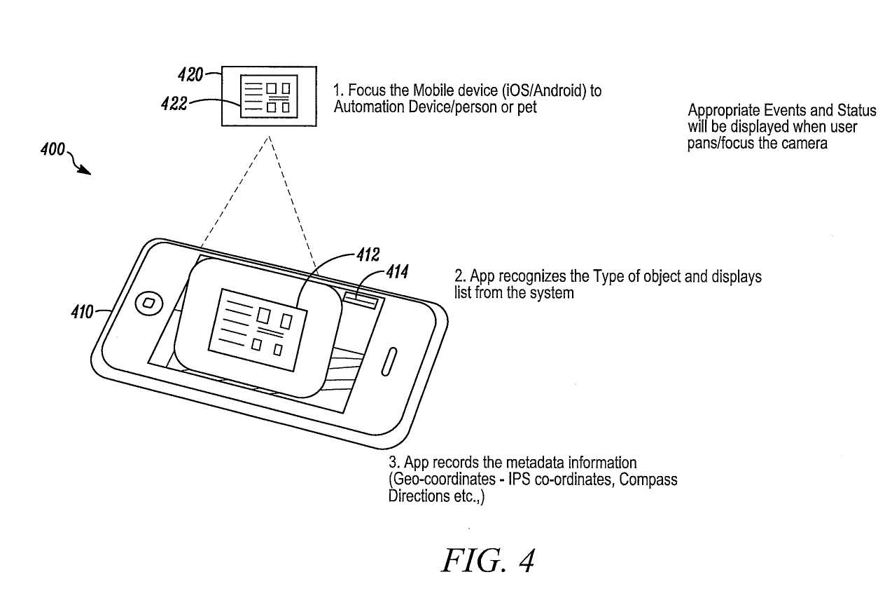

FIG. 4 is a perspective view of a system 400 for carrying out the methods of FIG. 1, FIG. 2 and others in accordance with disclosed embodiments. As seen in FIG. 4, the system 400 can include a remote control device 410 and an object to be controlled 420. For example, in some embodiments, the object to be controlled 420 can include a home automation device.

A camera or other type of image capturing device associated with the remote control device 410 can capture an image of the object to be controlled 420. Then, the device 410 and/or a software application running therein can recognize the object 420, display a user interface 412 on the viewing screen 414 of the device 410 that is substantially identical to a user interface 422 of the object 420, and identify coordinates, for example, from extracted metadata of the captured image, in accordance with embodiments disclosed herein. Alternatively, the device 410 and/or software application running therein can first identify coordinates in accordance with embodiments disclosed herein and then identify the object 420 associated with the identified coordinates, identify a user interface 422 associated with the identified object 420, and display the user interface 412 on the viewing screen 414 of the device 410, where the displayed user interface 412 is substantially identical to the identified user interface 422.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the sprit and scope of the invention.

What is claimed is:

1. A method comprising:
providing an object to be controlled, the object to be controlled having a first user interface;
providing a remote control device, the remote control device having a viewing screen;
capturing an image of the object;
using the image of the object to recognize the object; and
based on recognition of the object, displaying a second user interface on the viewing screen of the remote control device,
wherein the second user interface is substantially identical to the first user interface.

2. The method of claim 1 wherein the object to be controlled includes an automation device.

3. The method of claim 1 wherein the remote control device includes one of a cellular phone, a personal digital assistant, and a smart phone.

4. The method of claim 1 wherein capturing the image of the object includes using an image capturing device associated with the remote control device to take a picture of the object.

5. The method of claim 1 wherein using the image of the object to recognize the object includes comparing the image of the object with a plurality of stored images.

6. The method of claim 1 further comprising identifying coordinates and associating the identified coordinates with the object.

7. The method of claim 6 wherein identifying the coordinates includes identifying coordinates of the object or identifying coordinates of the remote control device.

8. The method of claim 6 wherein identifying the coordinates includes identifying compass directions, identifying a location in a region, identifying geographic coordinates, or identifying GPS coordinates.

9. The method of claim 1 further comprising associating the second user interface with the object.

10. A method comprising:
providing an object to be controlled, the object to be controlled having a first user interface;
providing a remote control device, the remote control device having a viewing screen and an image capturing device;
focusing the image capturing device on the object;
identifying coordinates;
identifying the object as being associated with the identified coordinates; and
based on identifying the object, displaying a second user interface on the viewing screen of the remote control device,
wherein the second user interface is substantially identical to the first user interface.

11. The method of claim 10 wherein the object to be controlled includes an automation device.

12. The method of claim 10 wherein the remote control device includes one of a cellular phone, a personal digital assistant, and a smart phone.

13. The method of claim 10 wherein focusing the image capturing device on the object includes the image capturing device capturing an image of the object.

14. The method of claim 10 wherein identifying the coordinates includes identifying coordinates of the object or identifying coordinates of the remote control device.

15. The method of claim 10 wherein identifying the coordinates includes identifying compass directions, identifying a location in a region, identifying geographic coordinates, or identifying GPS coordinates.

16. The method 10 wherein identifying the coordinates includes comparing the identified coordinates with a plurality of recognized coordinates, wherein each of the plurality of recognized coordinates is associated with a respective one of a plurality of objects to be controlled.

17. A system comprising:
a viewing screen;
an image capturing device;
a programmable processor; and
executable control software stored on a non-transitory computer readable medium,
wherein the image capturing device captures an image of an object, the object including a first user interface,
wherein, based on the image of the object, the programmable processor and the executable control software recognize the object,
wherein, based on recognition of the object, the programmable processor and the executable control software cause a second user interface to be displayed on the viewing screen, and
wherein the second user interface is substantially identical to the first user interface.

18. The system of claim 17 further comprising a coordinate determining device, wherein the coordinate determining device identifies coordinates, and wherein the programmable processor and the executable control software associate the identified coordinates with the object.

19. The system of claim 17 wherein the programmable processor and the executable control software associate the second user interface with the object.

20. The system of claim 17 further comprising a coordinate determining device,
wherein the image capturing device focuses on a second object, the second object including a third user interface,
wherein the coordinate determining device identifies coordinates,
wherein the programmable processor and the executable control software identifies the second object as being associated with the identified coordinates,
wherein, based on identifying the second object, the programmable processor and the executable control software cause a fourth user interface to be displayed don the viewing screen, and
wherein the fourth user interface is substantially identical to the third user interface.
